(19) United States
(12) Patent Application Publication
(10) Pub. No.: US 2005/0260951 A1
(43) Pub. Date: Nov. 24, 2005

(54) Tunable superconducting RF cavity

(76) Inventors: Chandrashekhar H. Joshi, Bedford, MA (US); Anil Mavanur, Woburn, MA (US); Chiu-Ying Tai, Chelmsford, MA (US)

Correspondence Address: Choate, Hall & Stewart, 53 State Street, Exchange Place, Boston, MA, 02109, US

(21) Appl. No.: 10/848,667

(22) Filed: May 19, 2004

(51) Int. Cl. H04B 1/40; H04B 1/04

(52) U.S. Cl. 455/77; 455/120; 455/340

(57) ABSTRACT

Tunable RF cavity. The cavity includes a magnetostrictive material coupled to the cavity and a magnetic coil configured to impress a magnetic field on the magnetostrictive material. Control circuitry energizes the magnetic coil to control the shape of the magnetostrictive material, thereby to control the length of the cavity to tune its resonant frequency.

### BACKGROUND OF THE INVENTION

This invention relates to superconducting RF cavities and more particularly to cavity tuners able to adjust the resonant frequency of a cavity with fast response time.

Large research particle accelerators are used to study the fundamental nature of matter and attempt to understand the origins of the universe. These large and complex machines use radio frequency (RF) energy to accelerate sub-atomic particles at speeds approaching the speed of light. Special accelerating structures known as RF cavities are used to enable the particles to absorb as much of the RF energy as possible thereby increasing their speed and energy. Recently, more efficient accelerating structures have been made using superconducting cavities. There are two types of superconducting RF cavities commonly used in particle accelerators depending on the scientific goals to be achieved—elliptical cavities and spoke cavities. The efficiency of superconducting cavities derives from the extremely low absorption of the RF energy by the superconducting walls of the cavity.

Elliptical cavities, shown in FIG. 1a, resemble a series of round door knobs welded together. Depending on the size of the particle accelerator, hundreds or even thousands of cavities are used along the length of the accelerator to achieve the high particle energy needed by scientists to probe matter at ever-smaller length scales.

The shape of the RF wave within the cavity is maintained by accurately (with near nanometer resolution) altering cavity length along its axis. This length adjustment process is known as cavity tuning. To achieve high-particle energy, all cavities in the particle accelerator must have exactly the same wave structure. Coordinating tuning throughout the length of the particle accelerator is referred to as synchronization. Generally, every cavity along the length of a particle accelerator must have a tuner.

Spoke cavities create an accelerating structure similar to elliptical cavities. Typical geometries of spoke cavities are shown in FIG. 1b. Like elliptical cavities, spoke cavities create a standing wave of RF energy that accelerates the beam of charged particles along its axis.

Microphonics can occur in such superconducting RF structures when external forces from mechanical, electrical, or cryogenic systems become coupled into the RF acceleration structure thereby producing mechanical vibration in the RF cavities. This vibration causes a shift in the resonant frequency of the cavity making it less effective in coupling energy into the particle to achieve a desired particle acceleration. Therefore, tuners are required for damping microphonics excitation and Lorentz detuning in high performance superconducting RF cavities. The Thomas Jefferson National Accelerator Facility (Jefferson Lab) located in Newport News, Virginia, is one of the facilities in the United States that has fostered cavity tuner development. FIG. 2 is a schematic illustration of a prior art Jefferson Lab tuner. This tuner includes a lead screw 10 and dead leg 12. The lead screw 10 and dead leg 12 are connected to cell holders 14 and 16 on opposite sides. One cell holder is rigid and the other is in two parts with an outer disk that pivots around the cell holder as a lead screw motor moves the disk. The pivot axis is perpendicular to the lead screw 10 and dead leg 12 and is connected to the cell holder. As the lead screw motor progresses, it rotates the disk, thereby pulling the outer cells apart. In this way, the length of the superconducting RF cavity is adjusted to maintain the resonant frequency of the RF energy in the cavity.

Prior art cavity tuners such as that shown in FIG. 2 have disadvantages because they utilize conventional actuators such as motors, solenoids and hydraulic actuators. Such conventional actuators have a significant stroke but there is a limit to the precision they can achieve. They are also impractical for applications in which a large force output is needed because they tend to become bulkier and consume large amounts of power. Further, such mechanical actuators present problems at cryogenic temperatures.

Cavity tuners based on piezoelectric actuators are also known but are proving to be inadequate to the task. Although piezoelectric actuators can respond in the time required, they have very limited stroke at cryogenic temperatures. The elongation at cryogenic temperatures of PZT, the most commonly used piezoelectric material, is reduced by a factor of 10 from its elongation at room temperature. Piezoelectric actuators also operate at high voltages (from 500 to 1000 v). This high voltage is not compatible with vacuum and cryogenic systems. This incompatibility results from breakdown and the damage that can occur to the vacuum integrity of a cryostat from flashovers in the actuators.

Piezoelectric actuators are produced as multilayer structures including thin laminations of the PZT materials sandwiched between insulating material—usually a ceramic or polymer. For long term operation, there is concern that the layers will delaminate causing degradation in the actuator performance with time.

It is therefore an object of the present invention to provide a cavity tuner uniquely suited for damping microphonics excitation and Lorentz detuning by providing high force, submicron resolution motion at cryogenic temperatures.

### SUMMARY OF THE INVENTION

According to one aspect of the invention a tunable RF cavity includes an RF cavity and a magnetostrictive material coupled to the cavity. A magnetic coil is configured to impress a magnetic field on the magnetostrictive material and circuitry is provided for energizing the magnetic coil to control the shape of the magnetostrictive material thereby to control the length of the cavity to tune its resonant frequency. In a preferred embodiment the cavity is a superconducting RF cavity and includes a plurality of cells. In this embodiment, it is preferred that the magnetic coil surround the magnetostrictive material.

In preferred embodiments, the magnetic coil and magnetostrictive material are mounted within a housing to form an actuator. The magnetostrictive material may be bulk material, laminated or powdered and bonded. Suitable actuator housing includes a soft ferromagnetic shielding such as silicon-steel. Suitable magnetostrictive materials are TbDyFe and TbDyZn.

The use of magnetostrictive materials results in a compact, high force, low power, high speed actuator. For the same size, the magnetostrictive actuator will produce larger forces than can conventional actuators. Magnetostrictive actuators are also very high speed with response time on the order of microseconds. Such actuators also provide backlash-free precision motion. The simple construction and controls result in actuators that can be readily retrofitted to existing particle accelerator systems. Finally, magnetostrictive actuators provide reliable, robust operation at cryogenic temperatures and in vacuum environments.

### BRIEF DESCRIPTION OF THE DRAWING

FIG. 1a is a perspective view of an elliptical superconducting radio frequency cavity.

FIG. 1b is a perspective view of a spoke cavity.

FIG. 2 is a cross-sectional view of a prior art RF cavity tuner system.

FIG. 3 is a bar graph illustrating the strain energy of piezoelectric and magnetostrictive materials.

FIG. 4 is a schematic illustration of a magnetostrictive actuator.

FIG. 5 is an illustration, partially in section, and with exploded parts, of an embodiment according to the invention.

FIG. 6 is a perspective view of another embodiment of the invention including a niobium shield.

FIG. 7 is a cross-sectional view of an embodiment of the invention without flux concentrators or shielding.

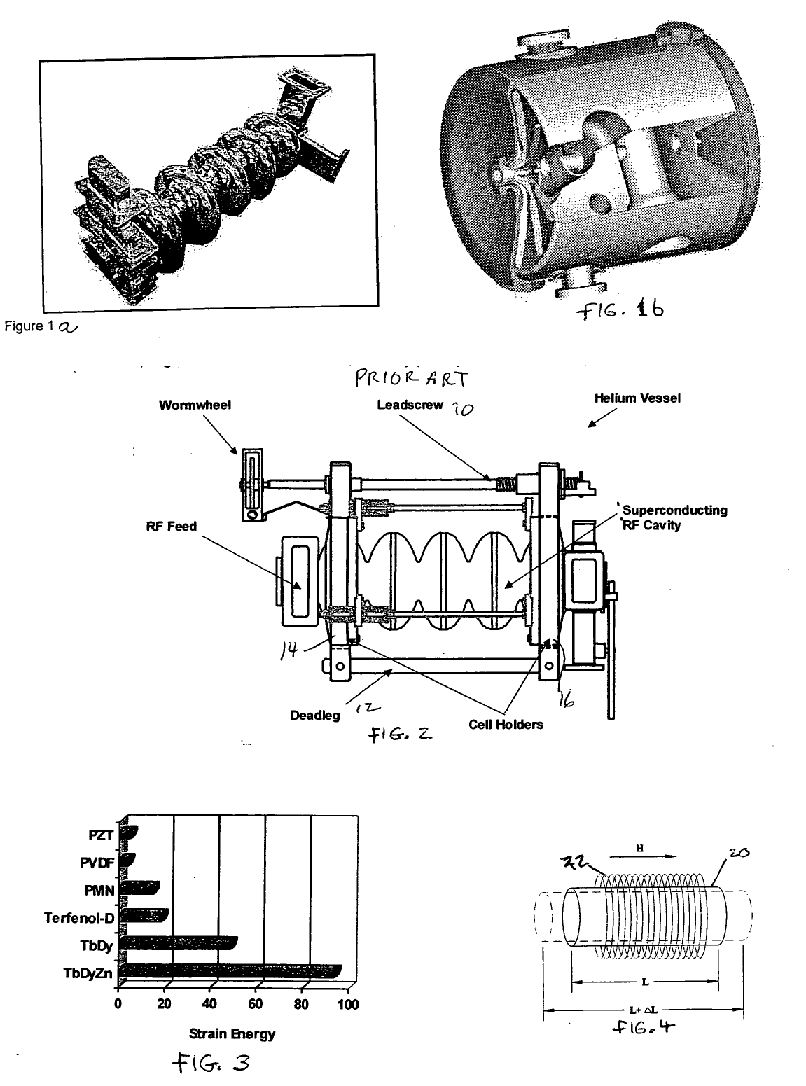

### DESCRIPTION OF THE PREFERRED EMBODIMENT

Some of the theory on which the present invention is based will now be described. While overall strain capability and force density are important in actuating material selection, what is important for the acoustic control applications disclosed herein is the ability of the material to absorb and remove acoustic energy from its surroundings. For the applications set forth in this specification, the correct figure of merit is strain energy given by the following equation:
E=½ Y_{SS}S²ₘₐₓ
wherein E is the strain energy, Y_{SS} is elastic modulus, and Sₘₐₓ is the saturation magnetostrictive strain of a given material. FIG. 3 compares the strain energy for several actuator materials. This figure shows that magnetostrictors such as TbDyZn and Terfenol-D have significantly higher strain energy than PZT, the most commonly used piezoelectric actuator material. Thus, for vibration damping for a particle accelerator, magnetostrictive actuators are more efficient. This improved efficiency translates directly into smaller actuator requirements. Furthermore, because of the efficiency gain, a drive system for the magnetostrictive actuator will be smaller, resulting in even greater decreases in overall system weight. The advantage of magnetostrictive materials along with the disadvantages discussed above of piezoelectric materials, makes magnetostrictive actuators a more attractive solution to the microphonics problem with respect to superconducting RF cavities.

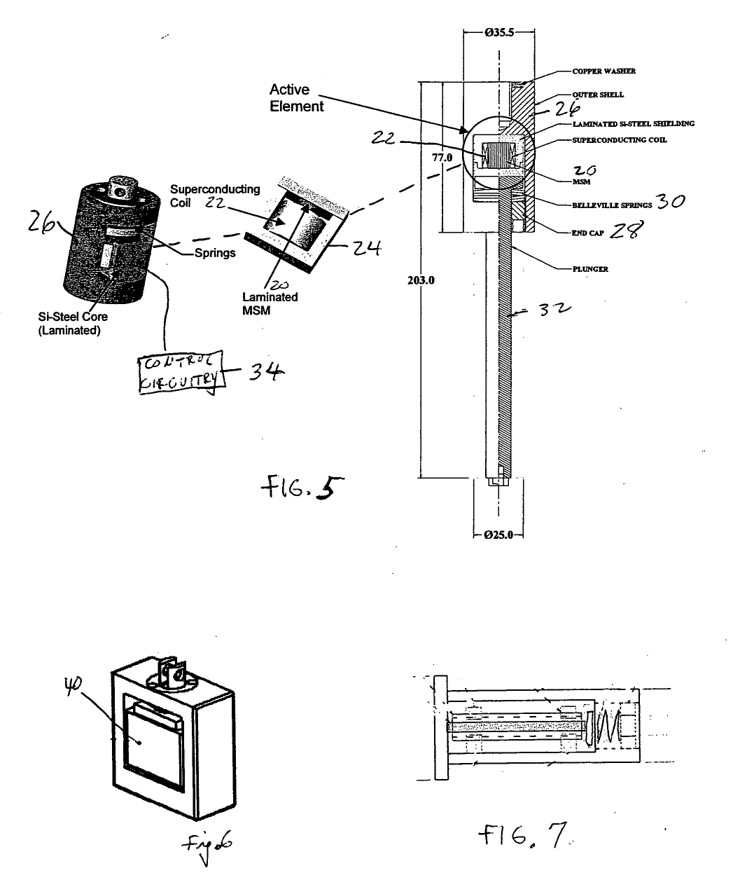

Magnetostrictors, sometimes referred to as magnetic smart materials (MSM), change their shape when exposed to a magnetic field. Magnetostriction arises from a reorientation of the atomic magnetic moments within the material. As illustrated in FIG. 4, magnetostrictors exhibit reversible dimensional changes in response to an externally applied magnetic field. In FIG. 4 a cylindrical magnetostrictor 20 has a nominal length L. The magnetostrictor 20 is positioned within a magnetic coil 22. When the magnetic coil 22 is energized, a magnetic field H is generated along the axis of the coil and the magnetostrictor 20 elongates to a length L+ΔL.

An actuator using the principle illustrated in FIG. 4 is shown in FIG. 5. As shown in FIG. 5, magnetostrictive material 20 resides within the magnetic coil 22. As can be seen in the inset, the magnetostrictive material 20 and magnetic coil 22 are mounted within a laminated silicon-steel shielding 24. The laminated silicon-steel shielding 24 concentrates the magnetic flux in the magnetostrictive material as well as providing magnetic shielding. The entire actuator may be shielded by a superconducting niobium sheath (not shown) in order to shield the magnetic field. The magnetostrictive material 20, coil 22 and shielding subassembly 24 are then placed inside an outer shell 26. The outer shell 26 in this embodiment is cylindrical with a rectangular slot cut into it. The magnetostrictive material 20 is preloaded using an end cap 28 along with Belleville springs 30. The motion of the magnetostrictive material 20 is transmitted by a plunger 32 that slides in the end cap 28. Those skilled in the art will realize that the plunger 32 may be coupled to a superconducting RF cavity in any desired way such as is illustrated in FIG. 2. Those skilled in the art will also appreciate that conventional control circuitry 34 is used to energize the magnetic coil 22 so as to precisely control the motion of the plunger 32. In that way, an RF cavity is tuned to its resonant frequency. A suitable controller 34 is available from Energen Inc. of Lowell, Mass.

Yet another embodiment of the invention is illustrated in FIG. 6 in which a niobium sheath 40 shields the magnetic field. Yet another embodiment of the invention is shown in FIG. 7. This is an embodiment without flux concentrators or shielding.

Returning again to FIG. 5, the magnetostrictive material 20 may be a piece of bulk material, it may be laminated or it may be a powdered and bonded magnetostrictive material such as KelvinAll™ available from Energen Inc. of Lowell, Mass. See, U.S. Pat. No. 6,451,131, the contents of which are incorporated herein by reference. Other magnetostrictive materials such as TbDyZn may be used. Further, other high-permeability and high-resistivity materials for flux concentration and magnetic shielding may be used. Configurations such as shown in FIG. 7 may be used with a different coil design.

It is recognized that modifications and variations will occur to those skilled in the art, and it is intended that all such modifications and variations be included within the scope of the appended claims.

1. Tunable RF cavity comprising:
an RF cavity;
a magnetostrictive material coupled to the cavity;
a magnetic coil configured to impress a magnetic field on the magnetostrictive material; and
circuitry for energizing the magnetic coil to control the shape of the magnetostrictive material, thereby to control the length of the cavity to tune its resonant frequency.

2. The RF cavity of claim 1 wherein the cavity is a superconducting RF cavity.

3. The RF cavity of claim 2 wherein the cavity is an elliptical cavity.

4. The RF cavity of claim 2 wherein the cavity is a spoke cavity.

5. The RF cavity of claim 3 wherein the cavity comprises a plurality of cells.

6. The RF cavity of claim 1 wherein the magnetic coil surrounds the magnetostrictive material.

7. The RF cavity of claim 6 wherein the magnetic coil and magnetostrictive material are mounted within a housing to form an actuator.

8. The RF cavity of claim 7 wherein the actuator includes a plunger for applying a force to the cavity.

9. The RF cavity of claim 1 wherein the magnetostrictive material is laminated.

10. The RF cavity of claim 1 wherein the magnetostrictive material is powdered and bonded.

11. The RF cavity of claim 7 wherein the housing is laminated silicon-steel shielding.

12. The RF cavity of claim 10 wherein the magnetostrictive material is TbDyFe.

13. The RF cavity of claim 1 wherein the magnetostrictive material is bulk material.
